(19) United States
(12) Patent Application Publication
(10) Pub. No.: US 2021/0133223 A1
(43) Pub. Date: May 6, 2021

(54) COMPUTERIZED SEARCH METHODOLOGY UTILIZING SELECTED DEVIATIONS

(71) Applicant: Volvo Car Corporation, Goteborg (SE)

(72) Inventors: Jon SENEGER, Boulder Creek, CA (US); Aykut YARARBAS, Cupertino, CA (US)

(21) Appl. No.: 16/670,070

(22) Filed: Oct. 31, 2019

(51) Int. Cl. G06F 16/332; G06F 16/338

(52) U.S. Cl. CPC G06F 16/3328; G06F 16/338

(57) ABSTRACT

A computerized method for searching a database, including: receiving one or more search terms from a user; generating a search payload incorporating the one or more search terms; first searching the database using the search payload; generating a first one or more hits resulting from the first searching including a first one or more highlights; formulating and presenting the user with one or more deviations using indexed metadata associated with the one or more hits; receiving selected of the one or more deviations from the user; second searching one or more of the database and the first one or more hits using the search payload incorporating the selected of the one or more deviations; and presenting a second one or more hits resulting from the second searching including a second one or more highlights.

### TECHNICAL FIELD

The present disclosure relates generally to a computerized search methodology utilizing selected deviations. This computerized search methodology is full-text and may be with schema or schema-less.

### BACKGROUND

A conventional full-text search is a classification tool that finds a best match from a database or collection of data based on a query consisting of one or more search terms, often provided in a natural language (NL) format. A full-text search is distinguished from a search based on metadata or on parts of the original text(s) presented in a database (such as title, abstract, excerpt, or bibliographical reference). In a full-text search, a search engine examines all of the words in every stored document or entry as it attempts to match search criteria. Many websites and mobile applications (apps) provide full-text-search capability, while others index and search only a portion of the documents or entries examined by their indexing systems. When dealing with a small number of documents or entries, it is possible for the full-text-search engine to directly (or serially) scan the contents of the documents or entries with each query. However, when the number of documents or entries to search is large and unmanageable, full-text searching is often divided into two tasks: indexing and searching. Indexing scans the text of all the documents or entries and builds a list of search terms. Then, while searching, when performing a specific query, only the index is referenced, rather than the text of the original documents or entries.

In a conventional full-text search, a given result cannot typically be enhanced, i.e. narrowed or widened based on terms that are not domain specific. Thus, the computerized search methodology of the present disclosure uses domain knowledge to classify search terms, while keeping specifics associated with a document or entry without being unique. This produces a series of suggested deviations from the original query with high precision. These deviations can then be pursued to obtain refined search results based on the original query.

### SUMMARY

More specifically, the computerized search methodology of the present disclosure uses domain knowledge to classify search terms using indexed metadata, while keeping specifics associated with a document or entry without being unique. This produces a series of suggested deviations from the original query with high precision. These deviations can then be pursued to obtain refined search results based on the original query and the deviations encompassed in a refined search payload. This search capability may be with schema or schema-less, meaning the original data may be ordered/structured or essentially freeform.

In one exemplary embodiment, the present disclosure provides a computerized method for searching a database or collection of data, including: receiving one or more search terms from a user via a search field of a user interface; generating a search payload incorporating the one or more search terms; first searching the database or collection of data using the search payload incorporating the one or more search terms; generating a first one or more hits resulting from the first searching including a first one or more highlights corresponding to the one or more search terms; formulating and presenting the user with one or more deviations associated with the one or more search terms using indexed metadata associated with the one or more hits; receiving selected of the one or more deviations from the user via the user interface; second searching one or more of the database or collection of data and the first one or more hits using the search payload incorporating the one or more search terms and the selected of the one or more deviations; and presenting a second one or more hits resulting from the second searching including a second one or more highlights corresponding to the one or more search terms via the user interface. The computerized method further includes presenting the first one or more hits resulting from the first searching including the first one or more highlights corresponding to the one or more search terms via the user interface. The computerized method further includes presenting the second one or more hits resulting from the second searching including the second one or more highlights corresponding to the one or more search terms and the selected of the one or more deviations via the user interface. The first searching and the second searching are full-text searches. The database or collection of data are one of with schema and schema-less. The second searching includes re-weighting the search payload incorporating the one or more search terms based on the selected of the one or more deviations. Optionally, the database or collection of data includes a collection of vehicle data and the indexed metadata includes details related to the vehicle data.

In another exemplary embodiment, the present disclosure provides a non-transitory computer-readable medium stored in a memory and executed by a processor to search a database or collection of data by executing the steps including: receiving one or more search terms from a user via a search field of a user interface; generating a search payload incorporating the one or more search terms; first searching the database or collection of data using the search payload incorporating the one or more search terms; generating a first one or more hits resulting from the first searching including a first one or more highlights corresponding to the one or more search terms; formulating and presenting the user with one or more deviations associated with the one or more search terms using indexed metadata associated with the one or more hits; receiving selected of the one or more deviations from the user via the user interface; second searching one or more of the database or collection of data and the first one or more hits using the search payload incorporating the one or more search terms and the selected of the one or more deviations; and presenting a second one or more hits resulting from the second searching including a second one or more highlights corresponding to the one or more search terms via the user interface. The steps further include presenting the first one or more hits resulting from the first searching including the first one or more highlights corresponding to the one or more search terms via the user interface. The steps further include presenting the second one or more hits resulting from the second searching including the second one or more highlights corresponding to the one or more search terms and the selected of the one or more deviations via the user interface. The first searching and the second searching are full-text searches. The database or collection of data are one of with schema and schema-less. The second searching includes re-weighting the search payload incorporating the one or more search terms based on the selected of the one or more deviations. Optionally, the database or collection of data includes a collection of vehicle data and the indexed metadata includes details related to the vehicle data. The user interface includes one of a web interface and a mobile app interface.

### BRIEF DESCRIPTION OF THE DRAWINGS

The present disclosure is illustrated and described with reference to the various drawings, in which like reference numbers are used to denote like system components/method steps, as appropriate, and in which:

FIG. 1 is a flow diagram illustrating one exemplary embodiment of the initial flow scheme of the present disclosure, as implemented in a computerized environment; and

FIG. 2 is a flow diagram illustrating one exemplary embodiment of the deviation flow scheme of the present disclosure, as implemented in a computerized environment.

### DESCRIPTION OF EMBODIMENTS

More specifically, the computerized search methodology of the present disclosure uses domain knowledge to classify search terms using indexed metadata, while keeping specifics associated with a document or entry without being unique. This produces a series of suggested deviations from the original query with high precision. These deviations can then be pursued to obtain refined search results based on the original query and the deviations encompassed in a refined search payload. This search capability may be with schema or schema-less, meaning the original data may be ordered/structured or essentially freeform.

In a vehicle search context, for example, or any other complex product context, vehicle data is indexed with vehicle detail metadata. Again, this vehicle data may be with schema or schema-less. A NL query can then be used to generate a search payload and generate a list of hits, which may be presented to a user via a user interface, such as a web page or mobile app. The present disclosure then uses the indexed metadata to generate a list of possible deviations that may be selected by the user to refine the search. All results are presented to the user with highlighting reflective of the original search and, optionally, the selected deviation(s).

By way of example, if the user's initial query is “silver,” “red,” and “wifi,” an initial list of available vehicles may be generated and presented by the search engine, highlighting these search terms and including vehicle identification number (VIN), vehicle specifications, vehicle price, a photo, etc. The user may also be presented with a list of suggested deviations or further queries, such as “exterior paint” for both “silver” and “red,” “wheels” for “silver,” “seats” for “red,” etc. Thus, the initial query is parsed to determine what indexed features the user was referencing in his or her initial query. If the user selects “seats” and wheels,” the search is performed again or the original list of hits is refined to more accurately reflect the user's original search intention. This is made possible by the indexed domain-specific metadata. In this manner, the benefit of the present system is that initial search results, which may cover numerous contexts, can be targeted to one or more contexts that are of interest to the user.

In general, the user is presented with an input field where he or she can enter his or her search query, which generates the corresponding search terms. Providing a schema-less search enables finding a match in any available property. The present disclosure defines a taxonomy specifically for the product or context at issue, which allows for subsequent weighting and scoring of the search when there are hits for the search terms. Each highlighted property thus has a matching schema defined, i.e. seat or exterior for a color, etc. This allows the search engine to respond to the user's query with a greater degree of certainty and refinement. This is different from conventional full-text search in that the original query is selectively deviated from.

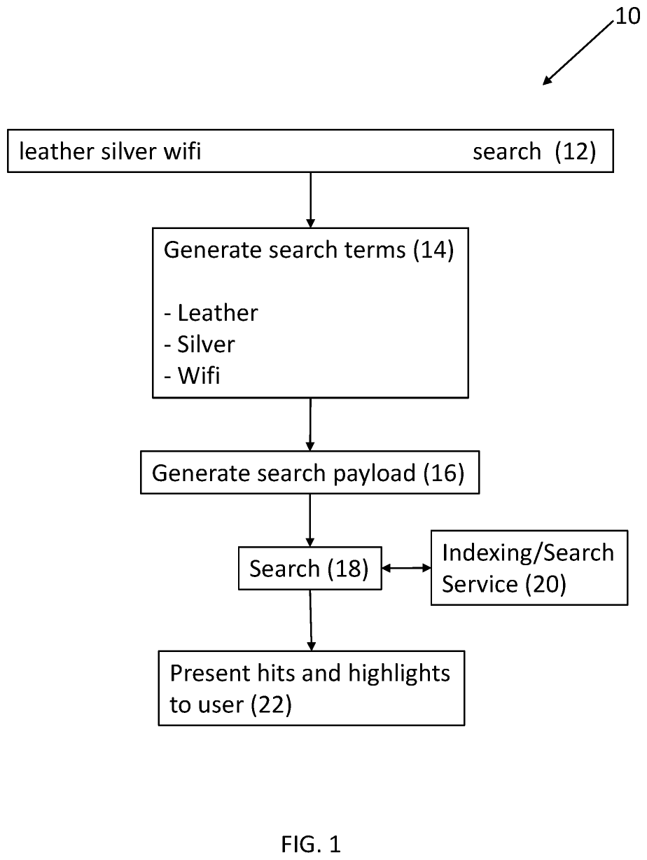

Referring now specifically to FIG. 1, in one exemplary embodiment, the initial method 10 begins with the user entering a query consisting of keywords in the search field of a web page or mobile application user interface (12). This query is used to generate search terms (14) and ultimately a search payload (16), as is conventional. Using this search payload, a search is performed (18), which may be accomplished using an external indexing/search service (20). Hits are then presented to the user (22), and preferably include highlights related to the search terms. Thus, each result includes an element that contains information about the thing or things that the user is searching for, e.g. a vehicle. Each result also includes an element that contains the highlights, including property names and values corresponding to the matching search terms, and suggested deviations, as described in greater detail below.

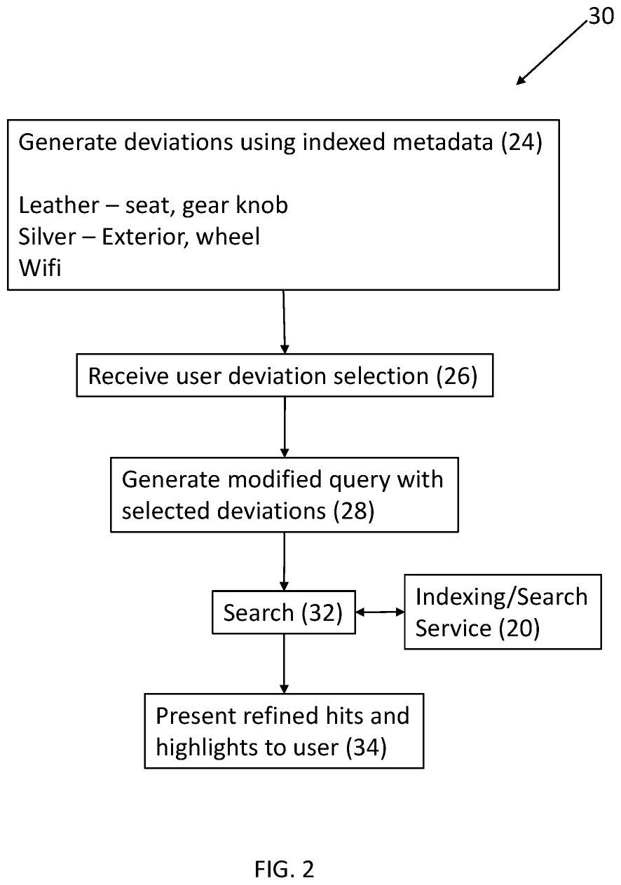

Referring now specifically to FIG. 2, in one exemplary embodiment, the subsequent method 30 the search engine generates one or more proposed deviations based on indexed metadata associated with the hits and search terms (24). The user considers these deviations as appropriate and selects one or more that would beneficially refine the hits, if any (26). A modified query is then generated by the search engine incorporating the selected deviations (28). Using this modified search payload, a search is performed (32), which may again be accomplished using an external indexing/search service (20). Refined hits are then presented to the user (34), and preferably include highlights related to the search terms and deviations. Thus, the original hits are displayed to the user with appropriate highlights and associated properties or deviations. These properties or deviations are then selected to refine the original hits. The refined query incorporates the original search terms and the selected properties or deviations. Specific attributes are presented with the results.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted as one or more instructions or code on a computer-readable medium and executed by a hardware-based processing unit. Computer-readable media may include computer-readable storage media, which corresponds to tangible media, such as data storage media, or communication media, including any medium that facilitates transfer of a computer program from one place to another, e.g., according to a communication protocol. In this manner, computer-readable media generally may correspond to (1) a tangible computer-readable storage medium that is non-transitory or (2) a communication medium, such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can include random-access memory (RAM), read-only memory (ROM), electrically erasable-programmable read-only memory (EEPROM), compact disc read-only memory (CD-ROM) or other optical disc storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared (IR), radio frequency (RF), and microwave, then the coaxial cable, fiber optic cable, twisted pair, DSL, or wireless technologies, such as IR, RF, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), complex programmable logic devices (CPLDs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Thus, the present disclosure provides a computerized method for searching a database or collection of data, including: receiving one or more search terms from a user via a search field of a user interface; generating a search payload incorporating the one or more search terms; first searching the database or collection of data using the search payload incorporating the one or more search terms; generating a first one or more hits resulting from the first searching including a first one or more highlights corresponding to the one or more search terms; formulating and presenting the user with one or more deviations associated with the one or more search terms using indexed metadata associated with the one or more hits; receiving selected of the one or more deviations from the user via the user interface; second searching one or more of the database or collection of data and the first one or more hits using the search payload incorporating the one or more search terms and the selected of the one or more deviations; and presenting a second one or more hits resulting from the second searching including a second one or more highlights corresponding to the one or more search terms via the user interface. The computerized method further includes presenting the first one or more hits resulting from the first searching including the first one or more highlights corresponding to the one or more search terms via the user interface. The computerized method further includes presenting the second one or more hits resulting from the second searching including the second one or more highlights corresponding to the one or more search terms and the selected of the one or more deviations via the user interface. The first searching and the second searching are full-text searches. The database or collection of data are one of with schema and schema-less. The second searching includes re-weighting the search payload incorporating the one or more search terms based on the selected of the one or more deviations. Optionally, the database or collection of data includes a collection of vehicle data and the indexed metadata includes details related to the vehicle data.

The present disclosure also provides a non-transitory computer-readable medium stored in a memory and executed by a processor to search a database or collection of data by executing the steps including: receiving one or more search terms from a user via a search field of a user interface; generating a search payload incorporating the one or more search terms; first searching the database or collection of data using the search payload incorporating the one or more search terms; generating a first one or more hits resulting from the first searching including a first one or more highlights corresponding to the one or more search terms; formulating and presenting the user with one or more deviations associated with the one or more search terms using indexed metadata associated with the one or more hits; receiving selected of the one or more deviations from the user via the user interface; second searching one or more of the database or collection of data and the first one or more hits using the search payload incorporating the one or more search terms and the selected of the one or more deviations; and presenting a second one or more hits resulting from the second searching including a second one or more highlights corresponding to the one or more search terms via the user interface. The steps further include presenting the first one or more hits resulting from the first searching including the first one or more highlights corresponding to the one or more search terms via the user interface. The steps further include presenting the second one or more hits resulting from the second searching including the second one or more highlights corresponding to the one or more search terms and the selected of the one or more deviations via the user interface. The first searching and the second searching are full-text searches. The database or collection of data are one of with schema and schema-less. The second searching includes re-weighting the search payload incorporating the one or more search terms based on the selected of the one or more deviations. Optionally, the database or collection of data includes a collection of vehicle data and the indexed metadata includes details related to the vehicle data. The user interface includes one of a web interface and a mobile app interface.

In terms of workflow breakdown, the user inputs keywords that are used to generate both the original and modified searches. The system performs the searches and displays the results to the user, including highlights that are viewed by the user. The system also generates deviations that are selected by the user to refine the original search. Ultimately, refined results and highlights are displayed to the user, with available drill-downs to specific search result entries.

Although the present disclosure is illustrated and described herein with reference to preferred embodiments and specific examples thereof, it will be readily apparent to persons of ordinary skill in the art that other embodiments and examples may perform similar functions and/or achieve like results. All such equivalent embodiments and examples are within the spirit and scope of the present invention, are contemplated thereby, and are intended to be covered by the following non-limiting claims for all purposes.

1. A computerized method for searching a database or collection of data, comprising:
receiving one or more search terms from a user via a search field of a user interface;
generating a search payload incorporating the one or more search terms;
first searching the database or collection of data using the search payload incorporating the one or more search terms;
generating a first one or more hits resulting from the first searching including a first one or more highlights corresponding to the one or more search terms;
formulating and presenting the user with one or more deviations associated with the one or more search terms using indexed domain-specific contextual metadata associated with the one or more hits, wherein each of the one or more deviations is visually associated with a related one or more of the one or more search terms via the user interface;
receiving selected of the one or more deviations from the user via the user interface;
second searching one or more of the database or collection of data and the first one or more hits using another search payload incorporating the one or more search terms and the selected of the one or more deviations; and
presenting a second one or more hits resulting from the second searching including a second one or more highlights corresponding to the one or more search terms via the user interface.

2. The computerized method of claim 1, further comprising presenting the first one or more hits resulting from the first searching including the first one or more highlights corresponding to the one or more search terms via the user interface.

3. The computerized method of claim 1, further comprising presenting the second one or more hits resulting from the second searching including the second one or more highlights corresponding to the one or more search terms and the selected of the one or more deviations via the user interface.

4. The computerized method of claim 1, wherein the first searching and the second searching are full-text searches.

5. The computerized method of claim 1, wherein the database or collection of data are one of with schema and schema-less.

6. The computerized method of claim 1, wherein the second searching comprises re-weighting the search payload incorporating the one or more search terms based on the selected of the one or more deviations.

7. The computerized method of claim 1, wherein the database or collection of data comprises a collection of vehicle data and the indexed metadata comprises details related to the vehicle data.

8. A non-transitory computer-readable medium stored in a memory and executed by a processor to search a database or collection of data by executing the steps comprising:
receiving one or more search terms from a user via a search field of a user interface;
generating a search payload incorporating the one or more search terms;
first searching the database or collection of data using the search payload incorporating the one or more search terms;
generating a first one or more hits resulting from the first searching including a first one or more highlights corresponding to the one or more search terms;
formulating and presenting the user with one or more deviations associated with the one or more search terms using indexed domain-specific contextual metadata associated with the one or more hits, wherein each of the one or more deviations is visually associated with a related one or more of the one or more search terms via the user interface;
receiving selected of the one or more deviations from the user via the user interface;
second searching one or more of the database or collection of data and the first one or more hits using another search payload incorporating the one or more search terms and the selected of the one or more deviations; and
presenting a second one or more hits resulting from the second searching including a second one or more highlights corresponding to the one or more search terms via the user interface.

9. The non-transitory computer-readable medium of claim 8, the steps further comprising presenting the first one or more hits resulting from the first searching including the first one or more highlights corresponding to the one or more search terms via the user interface.

10. The non-transitory computer-readable medium of claim 8, the steps further comprising presenting the second one or more hits resulting from the second searching including the second one or more highlights corresponding to the one or more search terms and the selected of the one or more deviations via the user interface.

11. The non-transitory computer-readable medium of claim 8, wherein the first searching and the second searching are full-text searches.

12. The non-transitory computer-readable medium of claim 8, wherein the database or collection of data are one of with schema and schema-less.

13. The non-transitory computer-readable medium of claim 8, wherein the second searching comprises re-weighting the search payload incorporating the one or more search terms based on the selected of the one or more deviations.

14. The non-transitory computer-readable medium of claim 8, wherein the database or collection of data comprises a collection of vehicle data and the indexed metadata comprises details related to the vehicle data.

15. The non-transitory computer-readable medium of claim 8, wherein the user interface comprises one of a web interface and a mobile app interface.

16. A computerized method for searching a database or collection of data, comprising:
receiving one or more search terms from a user via a search field of a user interface;
generating a search payload incorporating the one or more search terms;
first searching the database or collection of data using the search payload incorporating the one or more search terms;
generating a first one or more hits resulting from the first searching including a first one or more highlights corresponding to the one or more search terms;
formulating and presenting the user with one or more deviations associated with the one or more search terms using indexed domain-specific contextual metadata associated with the one or more hits, wherein each of the one or more deviations is visually associated with a related one or more of the one or more search terms via the user interface;
receiving selected of the one or more deviations from the user via the user interface;
second searching one or more of the database or collection of data and the first one or more hits using another search payload incorporating the one or more search terms and the selected of the one or more deviations; and
presenting a second one or more hits resulting from the second searching including a second one or more highlights corresponding to the one or more search terms via the user interface;
wherein the one or more search terms comprise one or more vehicle-related search terms, the one or more deviations comprises one or more vehicle feature-related deviations, and the indexed domain-specific contextual metadata comprises indexed vehicle feature-related metadata.

17. The computerized method of claim 16, further comprising presenting the first one or more hits resulting from the first searching including the first one or more highlights corresponding to the one or more search terms via the user interface.

18. The computerized method of claim 16, further comprising presenting the second one or more hits resulting from the second searching including the second one or more highlights corresponding to the one or more search terms and the selected of the one or more deviations via the user interface.

19. The computerized method of claim 16, wherein the first searching and the second searching are full-text searches and the database or collection of data are one of with schema and schema-less.

20. The computerized method of claim 16, wherein the second searching comprises re-weighting the search payload incorporating the one or more search terms based on the selected of the one or more deviations.
